(19) United States
(12) Patent Application Publication
(10) Pub. No.: US 2008/0001030 A1
(43) Pub. Date: Jan. 3, 2008

(54) Method of controlling aerodynamic characteristics of spiked flying object, and spiked flying object

(75) Inventors: Hiroaki Kobayashi, Tokyo (JP); Katsuyoshi Fukiba, Tokyo (JP); Motoyuki Hongoh, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: JAPAN AEROSPACE EXPLORATION AGENCY, Tokyo (JP)

(21) Appl. No.: 11/812,295

(22) Filed: Jun. 18, 2007

(30) Foreign Application Priority Data
Jun. 20, 2006 (JP) 2006-169679

(51) Int. Cl. B64C 13/00

(52) U.S. Cl. 244/99.12

(57) ABSTRACT

To provide a method of controlling the aerodynamic characteristics of a spiked flying object with an easy method without using a complicated variable mechanism or fluid energy supply system. A plurality of injection holes that are communicated with an internal channel are disposed on the front portion of a hollow shaft, and a valve for opening/closing an outlet section is disposed on the outlet section of the hollow shaft, to change either or both the opening/closing speed Vf of the valve and the duty ratio DR of the valve by means of a valve driver, whereby the aerodynamic characteristics of the hollow shaft are suitably controlled.

### BACKGROUND OF THE INVENTION

1. Field of the Invention

The present invention relates to a method of controlling the aerodynamic characteristics of a spiked flying object and the spiked flying object, more particularly to a method of controlling the aerodynamic characteristics of a spiked flying object with an easy method without using a complicated variable mechanism or fluid energy supply system, and to the spiked flying object.

2. Description of the Related Art

An aerodynamic variable technology is used for changing the shape of a section that receives aerodynamic force (aerodynamic configuration) according to environmental conditions. A variety of variable mechanisms such as a flap, a variable swept wing, an aerobrake, and a variable stator blade of a compressor are already mounted in an aircraft, contributing to the improvement of the aerodynamic performance and propulsive performance. However, the problem is the increased weight of such aircraft that is caused by mounting the driving force source for freely deforming the aerodynamic configuration, and the complicated structure thereof. As an aerodynamic variable mechanism having a relatively simple structure, there is an idea of controlling the aerodynamic characteristics of a flying object by extending an aerospike (a spike shaft attached to the front nose of the flying object) (see FIG. 8 of U.S. Pat. No. 4,650,139, for example), but the problem of this idea is that the flow region around the spike shaft becomes unstable by extending the aerospike. In addition to this idea, there is an idea of, instead of extending the spike, injecting inactive gas or combustion gas from the tip of the spike to reduce drag (see FIG. 9 of U.S. Pat. No. 4,650,139, for example), but the problem of this idea is the increase of weight caused by mounting the gas source or ignition source.

### SUMMARY OF THE INVENTION

As described above, the conventional aerospike having a variable mechanism for changing the spike length has a drawback of destabilizing the flow region around the spike shaft by extending the aerospike, while the other aerospike having a fluid supply system for injecting inactive gas or combustion gas from the tip of the spike has a drawback of increasing the weight of the aerospike by mounting the inactive gas source or the ignition source.

The present invention is therefore contrived in view of the above-described circumstances, and an object thereof is to provide a method of controlling the aerodynamic characteristics of a spiked flying object by using an easy method without using a complicated variable mechanism or fluid energy supply system, and the spiked flying object.

In order to achieve the above object, a method of controlling aerodynamic characteristics of a spiked flying object according to claim 1 is characterized in having the steps of: disposing, on an outer surface of a front portion of a spike, a plurality of injection holes or slits that are communicated with an internal channel; disposing a valve for opening/closing an air flow flowing through the internal channel; and controlling the aerodynamic characteristics of the spike by changing either or both an opening/closing speed of the valve and a duty ratio of an opening time of the valve.

In the abovementioned method of controlling aerodynamic characteristics of a spiked flying object, when the valve at a spike outlet section is closed, an overflow of the air from the injection holes at the front portion of the spike makes an air flow adjacent to the outer surface of the spike separated therefrom, whereby separated flow areas caused by the overflows are enlarged. Accordingly, shock waves that are formed around the spike are weakened, and a drag coefficient (Cd) value is reduced. On the other hand, when the valve at the spike outlet section is opened, no overflow of the air flow to the outer surface of the spike, thus the air flow attaches to the most part of the outer surface of the spike, whereby the separated flow areas are narrowed. Accordingly, the shock waves that are formed around the spike are strengthened, and the Cd value is increased. As a result, the aerodynamic characteristics (drag) of the spike are changed in the form of pulses in accordance with the opening/closing speed of the valve at the spike outlet section, and the pulse duty ratio of the opening/closing of the valve is changed, whereby the drag can be adjusted to an arbitrary value.

In order to achieve the above object, a spiked flying object according to claim 2 has: a spike that has, on an outer surface of a front portion of the spike, a plurality of injection holes or slits communicated with an internal channel; a valve for opening/closing an air flow flowing through the internal channel; and valve controlling means for changing either or both an opening/closing speed of the valve and a duty ratio of an opening time of the valve, wherein the valve controlling means controls aerodynamic characteristics of the spike by changing either or both the opening/closing speed of the valve and the duty ratio of the opening time of the valve.

With the abovementioned spiked flying object, the method of controlling aerodynamic characteristics of a spiked flying object described in claim 1 can be suitably implemented.

In the spiked flying object according to claim 3, a section of the internal channel of the spike communicated with the injection holes or slits is formed into an enlarged channel.

By configuring the spiked flying object as described above, when the valve is opened, an air stream flowing in at supersonic speeds no longer decelerates in the vicinity of the injection holes, as a result of which almost no overflow comes from the injection holes, thus the aerodynamic characteristics control performance is suitably maintained without being lost.

According to the method of controlling aerodynamic characteristics of a spiked flying object, and the spiked flying object, the aerodynamic characteristics of the spike can be controlled easily without using a complicated variable mechanism or fluid energy supply system, and by disposing the plurality of injection holes or slits communicated with the internal channel at the front portion of the spike, and disposing the valve for opening/closing the internal channel of the spike to change either or both the opening/closing speed of the valve and the duty ratio of the opening time of the valve. Therefore, highly simplified and reliable aerodynamic characteristics control can be performed. Moreover, the required electric power for such control is the required one in opening/closing a small valve that opens/closes the internal channel of the spike, thus the aerodynamic characteristics control is excellent in energy saving performance. Also, by opening/closing the valve in the form of pulses, the Cd value of the flying object is changed in the form of pulses in response to the valve movement, and by changing the pulse duty ratio, the average Cd value can be adjusted to an arbitrary value. Accordingly, even with a flying object which does not have a thrust device or a movable vane, highly accurate trajectory control can be performed.

### BRIEF DESCRIPTION OF THE DRAWINGS

FIG. 1 is an explanatory diagram that shows a cross-sectional view of a substantial part of the spiked flying object of the present invention;

FIG. 2 is an explanatory diagram that shows a cross-sectional view of a substantial part of an outline of the method of controlling aerodynamic characteristics according to the present invention;

FIG. 3 is a graph showing the result of a test of the method of controlling aerodynamic characteristics by means of the spiked flying object;

FIG. 4 is a graph showing the relationship between a duty ratio DR and an average drag coefficient Cd_{avg}; and

FIG. 5 is a graph showing angle of attack characteristics of the drag in a state in which the valve is pulse-operated.

### DESCRIPTION OF THE PREFERRED EMBODIMENTS

Hereinafter, the present invention is described in further detail with reference to the embodiments shown in the figures. It should be noted that the present invention is not limited by these embodiments.

FIG. 1 is an explanatory diagram that shows a cross-sectional view of a substantial part of a spiked flying object 100 of the present invention.

This flying object 100 is comprised by: a cylindrical body part 1 in which a payload, a fuel tank, a thrust device and the like are mounted; a hollow shaft 2 which is the spike controlling the aerodynamic characteristics, being attached to the front portion of the body part 1 and extended in an axial direction thereof; a valve 3 which opens/closes an outlet section 24 of an internal channel 22 of the hollow shaft 2; exhaust slits 4 for the air flowing out to the outside which flows out from the outlet section 24; and a valve driver 5, which is the valve controlling means for changing either the opening/closing speed of the valve and the duty ratio of the opening time of the valve 3.

The hollow shaft 2 has a hollow structure with the internal channel 22. Air flowing from an inlet section 21 passes through the internal channel 22, and when the valve 3 is opened, flows out from the exhaust slits 4 via the outlet section 24 to the outside. When, on the other hand, the valve 3 is closed, the air flowing from the inlet section 21 cannot flow out from the outlet section 24 because the valve 3 is closed, and thus flows out as an overflow from an injection hole 23 to the outside. It should be noted that a slit-shaped injection port may be adopted in place of the tubular injection hole 23.

It is preferred that the length L of the hollow shaft 2 be approximately 2 through 2.5 times greater than the diameter D of the body part.

The valve 3 is comprised by: a solenoid 31 which is a driving source; a valve seat 32 that seals the outlet section 24 of the hollow shaft 2; and a valve shaft 33 that connects the solenoid 31 and the valve seat 32.

The exhaust slits 4 are opening sections that are in the form of, for example, a rectangle and are provided at even intervals and in a circumferential direction of the body part 1.

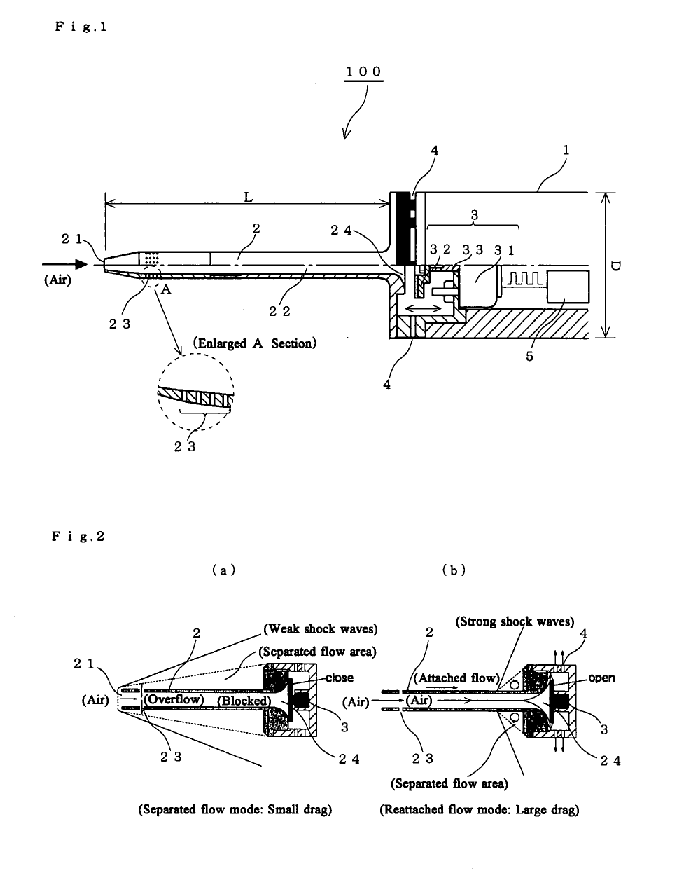

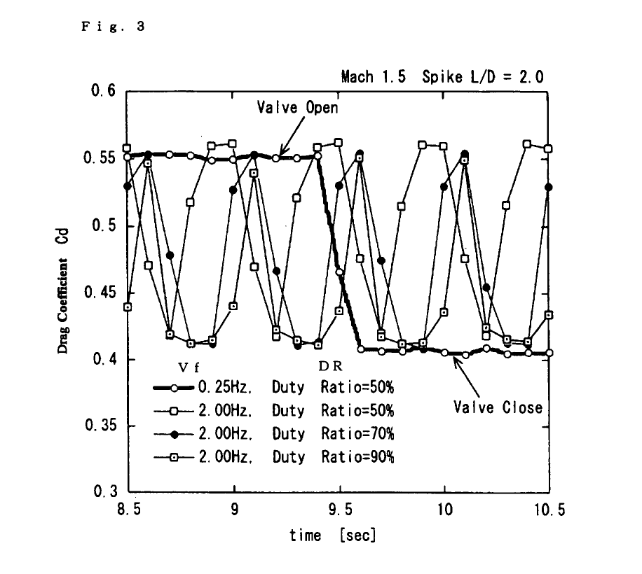

FIG. 2 is an explanatory diagram that shows a cross-sectional view of a substantial part of an outline of the method of controlling aerodynamic characteristics according to the present invention. It should be noted that FIG. 2(a) shows the closed state of the valve 3, while (b) shows the opened state of the valve 3.

As shown in FIG. 2(a), when the valve 3 is closed, the overflow from the injection hole 23 of the hollow shaft 2 makes an air flow adjacent to the shaft 2 separated therefrom, whereby the separated flow areas caused by the overflow are enlarged as the overflows flow toward a downstream. Accordingly, shock waves that are formed around the hollow shaft 2 are weakened, and a drag coefficient Cd value is reduced.

On the other hand, as shown in FIG. 2(b), when the valve 3 is opened, the air flow attaches to the most part of the hollow shaft 2 because the overflow does not flow to the outside of the hollow shaft 2, whereby the separated flow areas are narrowed. Accordingly, the shock waves formed around the hollow shaft 2 are strengthened, and the drag coefficient Cd value is increased. Furthermore, the intake air passes through the internal channel 22, flows out of the outlet section 24, and flow out from the exhaust slits 4 to the outside.

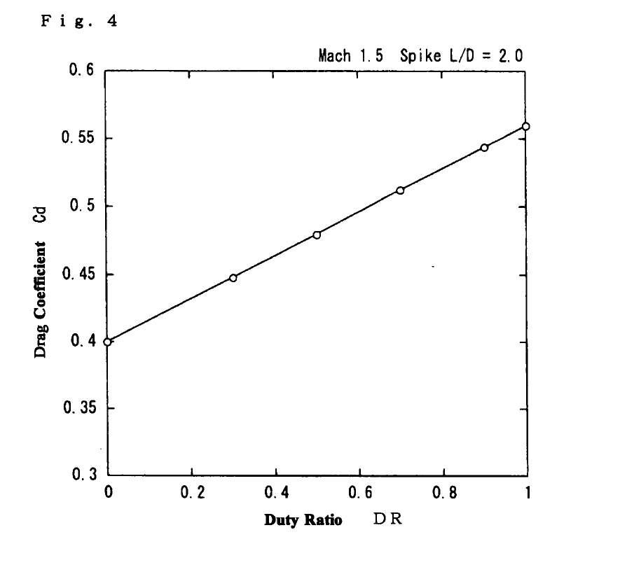

FIG. 3 is a graph showing the result of a test of the method of controlling aerodynamic characteristics by means of the spiked flying object 100. It should be noted that the spike length L of the spiked flying object/body part diameter D is 2.0, and air speed is mach 1.5.

A functionality verification test was carried out using a spiked flying object with a body diameter D=100 mm in a 1m×1 m supersonic wind tunnel of Japan Aerospace Exploration Agency (JAXA) Institute of Aerospace Technology.

According to the result showing, for example, the valve opening/closing speed Vf=0.25 [Hz] and the duty ratio DR=50%, the valve 3 started to close at around the time=9.4 [sec], and the drag coefficient Cd was reduced in response to the valve 3 movement. When the valve 3 was closed completely around the time=9.6 [sec], the drag coefficient Cd became substantially constant.

Similarly, when looking at a time change of the drag coefficient Cd in the case in which the valve opening/closing speed Vf is fixed to 2.00 [Hz] and the duty ratio DR is changed to 50%, 70% and 90%, it can be understood that the drag coefficient Cd changes in the form of pulses in accordance with the opening/closing operation of the valve 3. This indicates that by adjusting the valve opening/closing speed Vf and the duty ratio DR, the drag coefficient Cd can be controlled in the form of arbitrary pulses.

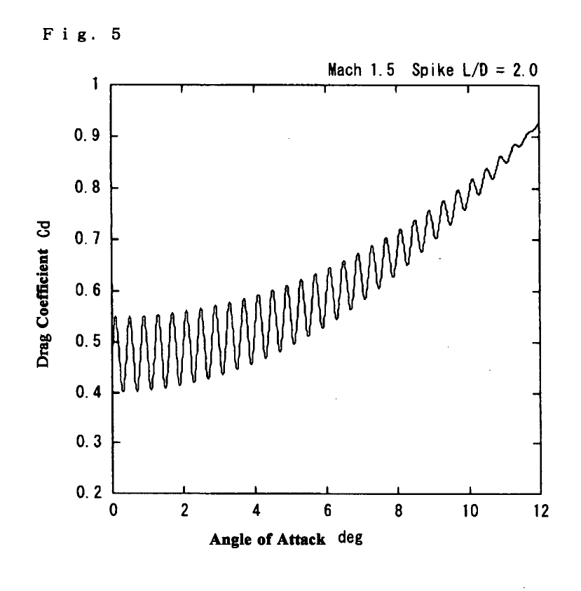

FIG. 4 is a graph showing the relationship between the duty ratio DR and an average drag coefficient Cd_{avg}. It should be noted that the average drag coefficient Cd_{avg} is a value obtained by time-averaging the integration values of the drag coefficients Cd shown in FIG. 3.

It can be understood from this graph that the duty ratio DR and the average drag coefficient Cd_{avg} are in a linear relationship. Therefore, this indicates that the average drag coefficient Cd_{avg} can be controlled by the duty ratio DR, that is, the aerodynamic characteristics of the flying object can be controlled by the duty ratio DR.

FIG. 5 is a graph showing angle of attack characteristics of the drag in a state in which the valve is pulse-operated.

It is confirmed from this graph that, even if the flying object has an angle of attack, the aerodynamic characteristics according to the present invention can be controlled at an angle of attack of 0° through 12° without losing the drag control performance.

The method of controlling aerodynamic characteristics of a spiked flying object and the flying object according to the present invention can be applied to the entire flying objects such as an aircraft, a rocket, and a microgravity experimental apparatus that fly in the air at high speeds.

What is claimed is:

1. A method of controlling aerodynamic characteristics of a spiked flying object, the method comprising the steps of:
disposing, on an outer surface of a front portion of a spike, a plurality of injection holes or slits communicated with an internal channel; disposing a valve for opening/closing an air flow flowing through the internal channel; and controlling the aerodynamic characteristics of the spike by changing either or both an opening/closing speed of the valve and a duty ratio of an opening time of the valve.

2. A spiked flying object, comprising: a spike that has, on an outer surface of a front portion of the spike, a plurality of injection holes or slits communicated with an internal channel; a valve for opening/closing an air flow flowing through the internal channel; and valve controlling means for changing either or both an opening/closing speed of the valve and a duty ratio of an opening time of the valve, wherein
the valve controlling means controls aerodynamic characteristics of the spike by changing either or both the opening/closing speed of the valve and the duty ratio of the opening time of the valve.

3. The spiked flying object according to claim 2, wherein a section of the internal channel of the spike communicated with the injection holes or slits is formed into an enlarged channel.
